(19) United States
(12) Patent Application Publication
(10) Pub. No.: US 2009/0234898 A1
(43) Pub. Date: Sep. 17, 2009

(54) METHOD OF GENERATING PULSE OF DIGITAL DIFFERENTIAL ANALYZER

(75) Inventors: RONG-HWANG HORNG, Tu-Cheng (TW); WEI-DER TANG, Tu-Cheng (TW); YAW-SHEN LAI, Tu-Cheng (TW); CHAU-LIN CHANG, Tu-Cheng (TW); TSANN-HUEI CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/205,123

(22) Filed: Sep. 5, 2008

(30) Foreign Application Priority Data
Mar. 11, 2008 (CN) 200810300523.2

(51) Int. Cl. G06J 1/02; G06F 7/38

(52) U.S. Cl. 708/102

(57) ABSTRACT

The present invention relates to a method of generating a pulse for a digital differential analyzer. The digital differential analyzer includes a counter, a shift register and an adder with a comparator. The beginning number P of the shift register, the beginning number L of the comparator, and the beginning number Q of the counter, are all set, according to the formula Q=int(0.5L+0.5). A pulse command is inputted into the shift register. The number of the shift register and the number of the counter are added. The sum of the addition step is compared to the number of the comparator. If the sum is greater than or equal to the number of the comparator, the digital differential analyzer generates a pulse.

### BACKGROUND

1. Field of the Invention

The invention generally relates to pulse generation and, more particularly, to a method of generating pulse for a digital differential analyzer.

2. Description of Related Art

A digital differential analyzer is a digital implementation of a differential analyzer. The digital differential analyzer multiplies an input pulse rate by a numeric fraction to acquire an output pulse rate. The digital differential analyzer generates a pulse command to control motion of a servo motor. A typical digital differential analyzer includes a shift register, a counter, and an adder having a comparator. An execution of the digital differential analyzer for a fixed clock rate usually includes the steps below.

In Step 1, the adder is added to the number of the shift register and the number of the counter.

In Step 2, the comparator compares the sum of the addition step with a number of the comparator.

In Step 3, if the sum of the addition step equals or exceeds that of the comparator, the digital differential analyzer generates a pulse.

A beginning number of the shift register is set once, a beginning number of the comparator is set eight times, and a beginning number of the counter is set zero times. For example, in the first calculation, the adder adds the number of the shift register and the number of the counter, for a sum less than the number of the comparator, such that the digital differential analyzer does not generate a pulse. The adder delivers the sum to the counter for saving therein, and the sum of the addition step becomes the number of the counter when the digital differential analyzer initiates the subsequent calculation. The number of the counter is now one. The calculation continues through steps 1 to 3. In the eighth calculation, the adder adds the number of the shift register and the number of the counter. The sum of the addition step equals the number of the comparator, and the digital differential analyzer generates a pulse. The sum of the addition step is subtracted from the number of the comparator and the sum of the subtraction step is sent to the counter and saved. The sum of the subtraction step now becomes the number of the counter when the digital differential analyzer initiates the subsequent calculation. The number of the counter is now zero.

In a multi-axis motion system, if an axis generates fewer pulses, motion of the axis may fall behind the other axes. For example, if a first digital differential analyzer generates only one pulse to control motion of a first servo motor in the first axis, the first digital differential analyzer generates the first pulse in the eighth calculation. The beginning number of the shift register is set four times, the beginning number of the comparator is set eight times, and the beginning number of the counter is set zero times. A second digital differential analyzer generates four pulses to control motion of a second servo motor in the second axis. The second digital differential analyzer generates the first pulse in the second calculation. The first pulse of the first digital differential analyzer and the second digital differential analyzer differ in six calculations, such that the motion of the first axis falls behind that of the second axis.

What is needed, therefore, is a method of generating a pulse for a digital differential analyzer to overcome the above-described shortcomings.

### BRIEF DESCRIPTION OF THE DRAWINGS

The components in the drawing are not necessarily drawn to scale, the emphasis instead being placed upon clearly illustrating the principles of the present invention.

FIG. 1 is a flowchart illustrating an embodiment of a method of generating a pulse for a digital differential analyzer.

FIG. 2 is a block diagram illustrating an embodiment of a digital differential analyzer.

FIG. 3 is a chart illustrating a counter of the digital differential analyzer of FIG. 2.

FIG. 4 is a chart illustrating another counter of the digital differential analyzer of FIG. 2.

Corresponding reference characters indicate corresponding parts. The exemplifications set out herein illustrate at least one preferred embodiment of the present method of generating a pulse for a digital differential analyzer, in one form, and such exemplifications are not to be construed as limiting the scope of the invention in any manner.

### DETAILED DESCRIPTION OF THE EMBODIMENT

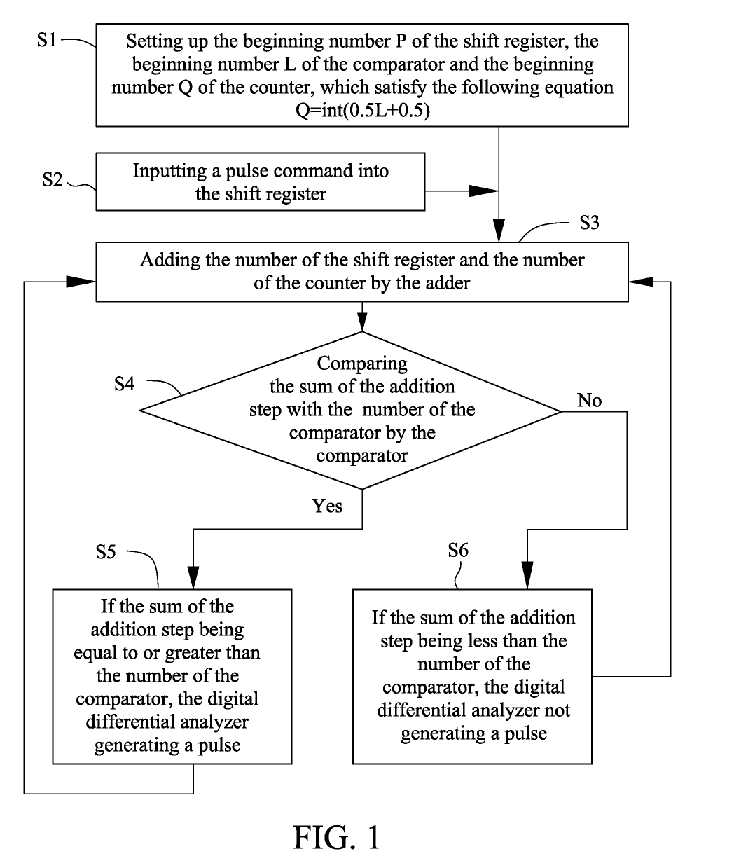

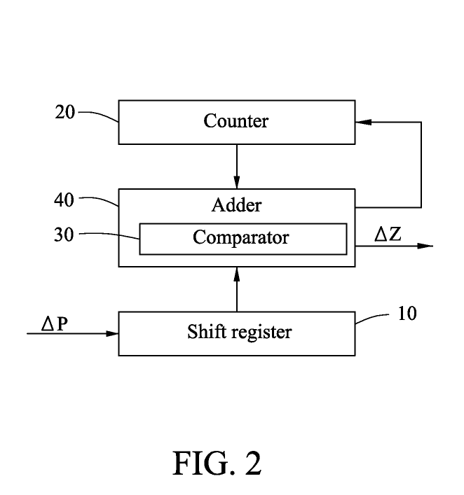

Referring to FIG. 1 and FIG. 2, an embodiment of a method of generating a pulse for a digital differential analyzer is provided. A digital differential analyzer includes a shift register 10, a counter 20 and an adder 40 with a comparator 30. Depending on the embodiment, certain of the steps described below may be removed, others may be added, and the sequence of steps may be altered.

In a step S1, a beginning number P of the shift register 10 is set, with the beginning number L of the comparator 30 and the beginning number Q of the counter 20, satisfying the formula:

Q=int(0.5L+0.5)

In a step S2, a pulse command ΔP is input into the shift register 10 at a fixed clock rate. The fixed clock rate is adjustable.

Continuing to a step S3, the adder 40 is added to the number P of the shift register 10 and the number Q of the counter 20.

Moving to a decision step S4, the comparator 30 compares the sum of the addition step with the number L of the comparator 30. If the sum (P+Q) of the addition step equals or exceeds the number L of the comparator 30, then the method continues to a step S5. If the sum (P+Q) of the addition step is less than the number L of the comparator 30, then the method moves to a step S6.

In the step S5, the digital differential analyzer generates a pulse (ΔZ=1). The sum (P+Q) of the addition step is subtracted from the number L of the comparator 30 and the result sent to the counter 20 and saved. The result (P+Q−L) of the subtraction step becomes the number Q of the counter 20 when the digital differential analyzer initiates the subsequent calculation.

In the step S6, no pulse is generated (ΔZ=0). The sum (P+Q) of the addition step is delivered to the counter 20 by adder 40 and saved. The sum (P+Q) of the addition step becomes the number Q of the counter 40 when the digital differential analyzer initiates the subsequent calculation.

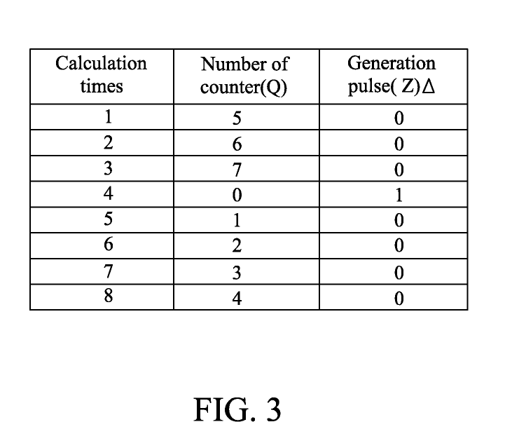

Referring to FIG. 3, the beginning number P of the shift register 10 is set once, the beginning number L of the comparator 30 is set eight times, and the beginning number Q of the counter 40 is set four times. The beginning number Q of the counter 40 satisfies the formula:

Q=int(0.5L+0.5)

If a first digital differential analyzer generates only one pulse to control the motion of a first servo motor in the first axis, then the first digital differential analyzer generates the first pulse in the fourth calculation.

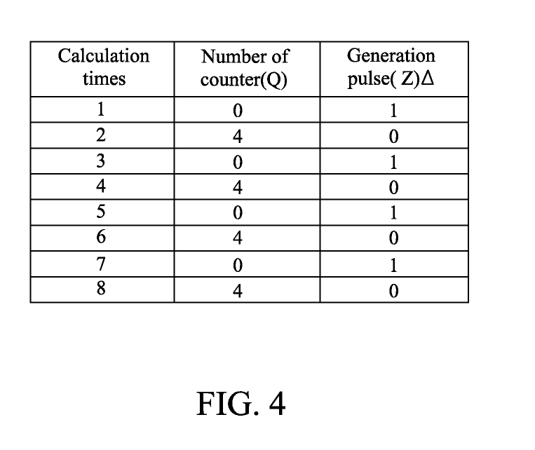

Referring to FIG. 4, the beginning number P of the shift register 10 is set four times, the beginning number L of the comparator 30 is set eight times, and the beginning number Q of the counter 40 is set four times. The beginning number Q of the counter 40 satisfies the formula:

Q=int(0.5L+0.5)

If a second digital differential analyzer generates four pulses to control the motion of a second servo motor in the second axis, then the second digital differential analyzer generates the first pulse in the first calculation.

It should be noted that the number Q of the counter 20 and the number L of the comparator 30 is adjustable and satisfies the formula:

Q=int(0.5L+0.5)

The first digital differential analyzer generates the first pulse in the fourth calculation, and is four calculation times faster than the typical digital differential analyzer. The first pulse of the first digital differential analyzer and the second digital differential analyzer have a gap of only three calculations. In a multi-axis motion system, the motion of the first axis will not fall behind the other axes.

It is to be understood that the above-described embodiment are intended to illustrate rather than limit the invention. Variations may be made to the embodiment without departing from the spirit of the invention as claimed. The above-described embodiment illustrate the scope of the invention but do not restrict the scope of the invention.

What is claimed is:

1. A method of generating a pulse for a digital differential analyzer, the digital differential analyzer comprising a counter, a shift register, and an adder having a comparator, the method comprising:
setting up a beginning number P of the shift register, a beginning number L of the comparator, and a beginning number Q of the counter, according to the formula:
Q=int(0.5L+0.5);
inputting a pulse command into the shift register;
adding the number of the shift register and the number of the counter;
comparing the sum of the addition step with the number of the comparator; if the sum of the addition step equals or exceeds the number of the comparator, generating a pulse.

2. The method of claim 1, wherein upon the condition the number of the addition step is greater than or equal to the number of the comparator, the number of the addition step is subtracted from the number of the comparator and the result is sent to the counter and saved, and the number of the subtraction step becomes the number of the counter when the digital differential analyzer initiates subsequent calculations.

3. The method of claim 2, wherein upon the condition the sum of the addition step is less than the number of the comparator, the result of the addition step is sent to the counter and saved by the adder, and the sum of the addition step becomes the number of the counter when the digital differential analyzer initiates subsequent calculations.

4. The method of claim 3, wherein the pulse command is inputted into the shift register at a fixed clock rate.
